(19) United States
(12) Patent Application Publication
(10) Pub. No.: US 2024/0188612 A1
(43) Pub. Date: Jun. 13, 2024

(54) Seasoning Composition and Method of Making a Gravy

(71) Applicant: James Smith, Akron, OH (US)

(72) Inventor: James Smith, Akron, OH (US)

(21) Appl. No.: 18/169,993

(22) Filed: Feb. 16, 2023

Related U.S. Application Data
(60) Provisional application No. 63/432,115, filed on Dec. 13, 2022.

(51) Int. Cl. A23L 27/10; A23L 23/00; A23L 27/16; A23L 27/22

(52) U.S. Cl. CPC A23L 27/105; A23L 23/00; A23L 27/16; A23L 27/22

(57) ABSTRACT

The present invention relates a seasoning composition and method of making a gravy, wherein the composition can be used as a stand-alone seasoning or as a gravy mix. The seasoning composition preferably has some combination of the following ingredients: seasoning salt, monosodium glutamate, onion powder, garlic powder, garlic salt, parsley, creole seasoning, parsley flakes, minced onions, lemon pepper seasoning, cayenne pepper, tenderizer, salt, and crushed red pepper. Said ingredient can also be used in a gravy seasoning mix to make gravy in a method of making a gravy by adding the mix to a gravy base made from oil, water, flour, and Worcestershire sauce.

### CROSS-REFERENCE TO RELATED APPLICATION

The present application claims priority to, and the benefit of, U.S. Provisional Application No. 63/432,115, which was filed on Dec. 13, 2022, and is incorporated herein by reference in its entirety.

### FIELD OF THE INVENTION

The present invention relates generally to the field of seasonings. More specifically, the present invention relates to a seasoning composition and method of making a gravy. The seasoning composition preferably has some combination of the following ingredients: seasoning salt, monosodium glutamate, onion powder, garlic powder, garlic salt, parsley, creole seasoning, parsley flakes, minced onions, lemon pepper seasoning, cayenne pepper, tenderizer, salt, and crushed red pepper. Said ingredient can also be used in a gravy seasoning mix to make gravy in a method of making a gravy by adding the mix to a gravy base made from oil, water, flour, and Worcestershire sauce. Accordingly, the present disclosure makes specific reference thereto. Nonetheless, it is to be appreciated that aspects of the present invention are also equally applicable to other like applications, devices, and methods of manufacture.

### BACKGROUND

Individuals who cook are constantly looking for new combinations of seasonings. Further, existing seasonings known in the art are one-dimensional and can typically only be used as a seasoning in various applications. A seasoning that can also be used in applications other than seasoning food would be advantageous and desirable to cooks

Therefore, there exists a long-felt need in the art for an improved seasoning. There also exists a long-felt need in the art for a seasoning composition and method of making a gravy that provides a unique seasoning blend and flavor profile. Further, there exists a long-felt need in the art for a seasoning composition and method of making a gravy that is more versatile than existing seasonings known in the art. More specifically, there exists a long-felt need in the art for a seasoning composition and method of making a gravy that can be used as a seasoning and used as a gravy mix.

The subject matter disclosed and claimed herein, in one embodiment thereof, comprises a seasoning composition and method of making a gravy. The seasoning composition preferably has some combination of the following ingredients: seasoning salt, monosodium glutamate, onion powder, garlic powder, garlic salt, parsley, creole seasoning, parsley flakes, minced onions, lemon pepper seasoning, cayenne pepper, tenderizer, salt, and crushed red pepper. Said ingredient can also be used in a gravy seasoning mix to make gravy in a method of making a gravy by adding the mix to a gravy base made from oil, water, flour, and Worcestershire sauce.

In this manner, the seasoning composition and method of making a gravy of the present invention accomplishes all the foregoing objectives and provides a unique seasoning blend and flavor profile. The seasoning composition and method of making a gravy can further be used as a seasoning and used as a gravy mix. As a result, the present invention is more versatile than existing seasonings known in the art.

### SUMMARY

The following presents a simplified summary to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a seasoning composition and method of making a gravy. The seasoning composition may vary in different embodiments to produce a plurality of flavor profiles. The seasoning composition preferably has some combination of the following ingredients: seasoning salt, monosodium glutamate, onion powder, garlic powder, garlic salt, parsley, creole seasoning, parsley flakes, minced onions, lemon pepper seasoning, cayenne pepper, tenderizer, salt, and crushed red pepper.

Some variation of the composition can also be used as a gravy seasoning mix. In this embodiment, a gravy base is created by combining oil, flour, Worchester sauce, and water. Some variation of the seasoning composition can then be added to the gravy base to create a seasoned gravy.

The present invention also includes a method of making a gravy using the gravy seasoning embodiment of the composition stated. First, vegetable oil is added to a skillet at medium-high heat and is stirred. Then, flour and Worcestershire sauce is added, and the mixture can be browned to the user's liking with occasional stirring. Next, water is incrementally added while reducing heat. Then, the seasoning composition can be added while whisking and simmering the mixture until the desired gravy consistency has been reached.

Accordingly, the seasoning composition and method of making a gravy of the present invention is particularly advantageous as it provides a unique seasoning blend with a unique flavor profile. In addition, the seasoning composition and method of making a gravy can further be used as a seasoning and also used as a gravy mix making it more versatile than existing seasonings known in the art. In this manner, the seasoning composition and method of making a gravy overcomes the limitations of existing seasonings known in the art.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a graphical view of the ingredients that can be used in any potential embodiment of a seasoning composition and method of making a gravy of the present invention in accordance with the disclosed architecture; and

FIG. 2 illustrates a flowchart for a method of making a gravy using a seasoning composition of a seasoning composition and method of making a gravy of the present invention in accordance with the disclosed architecture.

### DETAILED DESCRIPTION

The innovation is now described with reference to the drawings, wherein like reference numerals are used to refer to like elements throughout. In the following description, for purposes of explanation, numerous specific details are set forth to provide a thorough understanding thereof. It may be evident, however, that the innovation can be practiced without these specific details. In other instances, well-known structures and devices are shown in block diagram form to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for an improved seasoning. There also exists a long-felt need in the art for a seasoning composition and method of making a gravy that provides a unique seasoning blend and flavor profile. Further, there exists a long-felt need in the art for a seasoning composition and method of making a gravy that is more versatile than existing seasonings known in the art. More specifically, there exists a long-felt need in the art for a seasoning composition and method of making a gravy that can be used as a seasoning and used as a gravy mix.

The present invention, in one exemplary embodiment, is comprised of a seasoning composition and method of making a gravy. The seasoning composition may vary in different embodiments to produce a plurality of flavor profiles. The seasoning composition preferably has some combination of the following ingredients: seasoning salt, monosodium glutamate, onion powder, garlic powder, garlic salt, parsley, creole seasoning, parsley flakes, minced onions, lemon pepper seasoning, cayenne pepper, tenderizer, salt, and crushed red pepper.

Some variation of the composition can also be used as a gravy seasoning mix. In this embodiment, a gravy base is created by combining oil, flour, Worchester sauce, and water. Some variation of the seasoning composition can then be added to the gravy base to create a seasoned gravy. The method of making a gravy using the gravy seasoning embodiment of the composition involves first adding oil to a skillet at medium-high heat and stirring. Then, flour and Worcestershire sauce are added, and the mixture can be browned to the user's liking with occasional stirring. Next, water is incrementally added while reducing heat. Then, the seasoning composition can be added while whisking and simmering the mixture until the desired gravy consistency has been reached.

Accordingly, the seasoning composition and method of making a gravy of the present invention is particularly advantageous as it provides a unique seasoning blend with a unique flavor profile. In addition, the seasoning composition and method of making a gravy can further be used as a seasoning and also used as a gravy mix making it more versatile than existing seasonings known in the art. In this manner, the seasoning composition and method of making a gravy overcomes the limitations of existing seasonings known in the art.

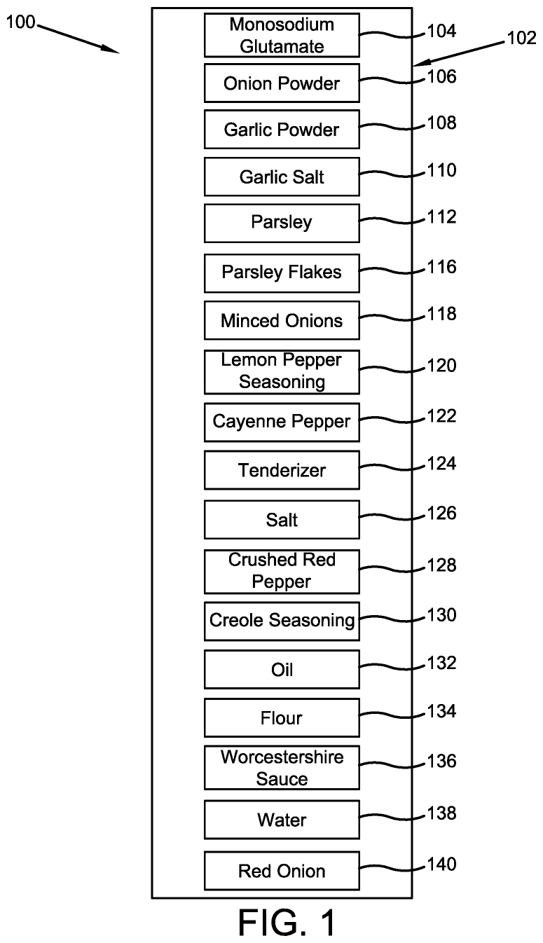

Referring initially to the drawings, FIG. 1 illustrates a graphical view of the ingredients that can be used in any potential embodiment of a seasoning composition and method of making a gravy 100 of the present invention in accordance with the disclosed architecture. The composition 100 is comprised of a plurality of ingredients. The exact proportions, amounts, weights, etc., of each ingredient may vary in different embodiments. In one embodiment, the composition 100 has ingredients in the following proportions, wherein the composition 100 is intended to be used as a seasoning blend:
1. 1 cup of seasoning salt 102
2. 1 cup monosodium glutamate 104
3. 1 cup onion powder 106
4. 1 cup garlic powder 108
5. 1 cup garlic salt 110 with parsley 112
6. 1 cup creole seasoning 130
7. 1 cup parsley flakes 116

In another embodiment, the composition 100 has ingredients in the following proportions, wherein the composition 100 is intended to be used as a seasoning blend:
1. 0.5 cup garlic powder 108
2. 0.5 cup monosodium glutamate 104
3. 0.5 cup of garlic salt 110 with parsley flakes 112
4. 0.5 cup onion powder 106
5. 0.5 cup lemon pepper seasoning 120
6. 0.25 cup cayenne pepper 122
7. 0.25 cup no salt tenderizer 124
8. 0.25 cup salt 126
9. 0.25 cup parsley flakes 112

In a further embodiment, the composition 100 has ingredients in the following proportions, wherein the composition 100 is intended to be used as a seasoning blend:
1. 0.5 cup garlic powder 108
2. 0.5 cup monosodium glutamate 104
3. 0.5 cup of garlic salt 110 with parsley flakes 112
4. 0.5 cup onion powder 106
5. 0.5 cup lemon pepper seasoning 120
6. 0.5 cup cayenne pepper 122
7. 0.25 cup no salt tenderizer 124
8. 0.25 cup salt 126
9. 0.25 cup parsley flakes 112

In a further embodiment, the composition 100 has ingredients in the following proportions, wherein the composition 100 is intended to be used as a seasoning blend:
1. 0.5 cup garlic powder 108
2. 0.5 cup monosodium glutamate 104
3. 0.5 cup of garlic salt 110 with parsley flakes 112
4. 0.5 cup onion powder 106
5. 0.5 cup lemon pepper seasoning 120
6. 0.5 cup cayenne pepper 122
7. 0.25 cup no salt tenderizer 124
8. 0.25 cup salt 126
9. 0.25 cup parsley flakes 112
10. 0.25 cup crushed red peppers

In addition, an embodiment of the composition 100 has ingredients in the following proportions, wherein the composition 100 is intended to be used as a seasoning blend used for making a gravy:
1. 4 TBSP garlic powder 108
2. 4 TBSP monosodium glutamate 104
3. 4 TBSP garlic salt 110 with parsley flakes 112
4. 4 TBSP seasoning salt
5. 4 TBSP minced onions 118
6. 4 TBSP creole seasoning 130

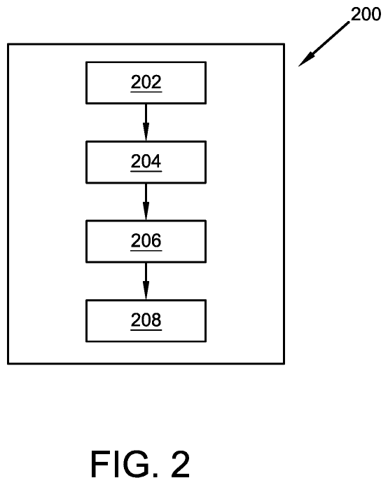

FIG. 2 illustrates a flowchart for a method of making a gravy 200 using a seasoning composition 102 of the seasoning composition and method of making a gravy 100 of the present invention in accordance with the disclosed architecture. The present invention also includes a method of making a gravy 200 using the gravy seasoning embodiment of the composition 100 stated supra. However, it should be noted that the gravy seasoning blend may incorporate ingredients of any described embodiment. First, 5 TBSP of vegetable oil 132 is added to a skillet (or any piece of cookware) at medium-high heat and is stirred [Step 202]. Then, 0.5 cup of flour 134 and 1 TBSP of Worcestershire sauce 136 are added and the mixture can be browned to the user's liking with occasional stirring [Step 204]. Next, 4 cups of water 138 are added, 0.25 cup at a time, while reducing heat [Step 206]. At this point, the seasoning composition 100 can be added while whisking and simmering the mixture at 185 degrees Fahrenheit for 10-20 minutes until the desired gravy consistency has been reached [Step 208].

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “seasoning composition and method of making a gravy” and “seasoning” are interchangeable and refer to the seasoning composition and method of making a gravy 100 of the present invention.

Notwithstanding the foregoing, the seasoning composition and method of making a gravy 100 of the present invention and its various components can be of any suitable size and configuration as is known in the art without affecting the overall concept of the invention, provided that they accomplish the above-stated objectives. One of ordinary skill in the art will appreciate that the size, configuration, and material of the seasoning composition and method of making a gravy 100 as shown in the FIGS. are for illustrative purposes only, and that many other sizes and shapes of the seasoning composition and method of making a gravy 100 are well within the scope of the present disclosure. Although the dimensions of the seasoning composition and method of making a gravy 100 are important design parameters for user convenience, the seasoning composition and method of making a gravy 100 may be of any size, shape, and/or configuration that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications, and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A seasoning composition comprising:
a seasoning salt;
a monosodium glutamate;
an onion powder;
a garlic powder;
a garlic salt with a parsley;
a creole seasoning; and
a parsley flake.

2. The seasoning composition of claim 1, wherein the monosodium glutamate is comprised of 1 cup of monosodium glutamate.

3. The seasoning composition of claim 1, wherein the seasoning salt is comprised of 1 cup of seasoning salt.

4. The seasoning composition of claim 1, wherein the onion powder is comprised of 1 cup of onion powder.

5. The seasoning composition of claim 1, wherein the garlic powder is comprised of 1 cup of garlic powder.

6. The seasoning composition of claim 1, wherein the garlic salt with a parsley is comprised of 1 cup of garlic salt with a parsley.

7. The seasoning composition of claim 1, wherein the creole seasoning is comprised of 1 cup of creole seasoning.

8. The seasoning composition of claim 1, wherein the parsley flakes is comprised of 1 cup of parsley flakes.

9. A seasoning composition comprising:
a garlic powder;
a monosodium glutamate;
a garlic salt with parsley flakes;
an onion powder;
a lemon pepper seasoning;
a cayenne pepper;
a no salt tenderizer;
a salt; and
a parsley flake.

10. The seasoning composition of claim 9, wherein the garlic powder is comprised of 0.5 cups of garlic powder.

11. The seasoning composition of claim 9, wherein the monosodium glutamate is comprised of 0.5 cups of monosodium glutamate.

12. The seasoning composition of claim 9, wherein the garlic salt with a parsley is comprised of 0.5 cups of garlic salt with a parsley.

13. The seasoning composition of claim 9, wherein the onion powder is comprised of 0.5 cups of onion powder.

14. The seasoning composition of claim 9, wherein the cayenne pepper is comprised of 0.25 cups of cayenne pepper.

15. The seasoning composition of claim 9, wherein the no salt tenderizer is comprised of 0.25 cups of no salt tenderizer.

16. The seasoning composition of claim 9, wherein the salt is comprised of 0.25 cups of salt.

17. The seasoning composition of claim 9, wherein the parsley flakes is comprised of 0.25 cups of parsley flakes.

18. A method of using a seasoning composition to make a gravy, the method comprising:
adding a vegetable oil to a piece of cookware at a medium-high heat;
stirring the vegetable oil;
adding a flour and a Worcestershire sauce to the vegetable oil;
browning the vegetable oil, the flour, and the Worcestershire sauce while stirring;
adding a water incrementally while reducing the medium-high heat;
adding a seasoning composition to the water, the vegetable oil, the flour, and the Worcestershire sauce; and
whisking and simmering the seasoning composition, the water, the vegetable oil, the flour, and the Worcestershire sauce while stirring to achieve the desired gravy consistency.

19. The method of claim 18, wherein the seasoning composition is comprised of a garlic powder, a monosodium glutamate, a garlic salt with a parsley flake, a garlic powder, a minced onion, and a creole seasoning.

20. The method of claim 18, wherein the simmering occurs at 185 degrees Fahrenheit.
